(19) United States
(12) Patent Application Publication
(10) Pub. No.: US 2026/0105625 A1
(43) Pub. Date: Apr. 16, 2026

(54) ELECTRONIC APPARATUS AND CONTROL METHOD THEREOF

(71) Applicant: SAMSUNG ELECTRONICS CO., LTD., Suwon-si (KR)

(72) Inventors: Minjin SONG, Suwon-si (KR); Jinhwi KIM, Suwon-si (KR); Jayoung YANG, Suwon-si (KR); Juhee JEONG, Suwon-si (KR); Joonyoung HEO, Suwon-si (KR)

(21) Appl. No.: 19/420,590

(22) Filed: Dec. 15, 2025

Related U.S. Application Data
(63) Continuation of application No. PCT/KR2024/095768, filed on Apr. 26, 2024.

(30) Foreign Application Priority Data
Jun. 16, 2023 (KR) 10-2023-0077755

(51) Int. Cl. G06T 7/70; A47L 9/28; H04L 12/28

(52) U.S. Cl. CPC G06T 7/70; A47L 9/2805; H04L 12/2809; H04L 12/282

(57) ABSTRACT

An electronic apparatus includes: a communication interface; a processor, and a memory storing instructions and travel map information, the instructions cause the electronic apparatus to: identify whether a home appliance is in a first captured image, based on the first captured image for the driving space being received through the communication interface; acquire identification information of the home appliance identified to be present based on the travel map information and the first captured image if the home appliance is identified to be present in the first captured image; acquire information on function provided by the identified home appliance based on the acquired identification information; identify information corresponding to the UI for providing a function of the identified home appliance together with the first captured image based on the acquired information on function; and transmit, to a user terminal, the information corresponding to the UI to a user terminal.

### CROSS-REFERENCE TO RELATED APPLICATIONS

This application is a continuation application of International Application No. PCT/KR2024/095768 designating the United States, filed on Apr. 26, 2024, in the Korean Intellectual Property Receiving Office and claiming priority to Korean Patent Application No. 10-2023-0077755, filed on Jun. 16, 2023, in the Korean Intellectual Property Office, the disclosures of which are incorporated by reference in their entireties.

### BACKGROUND

The present disclosure relates to an electronic apparatus and a control method thereof, and more particularly, to an electronic apparatus that provides information related to a function of a retrieved home appliance to a user terminal if the home appliance present in a home is retrieved from a captured image.

As electronic technology advances, various types of electronic apparatuses have been developed and become popular. Internet of things (IoT) technology has been actively developed, in which a plurality of apparatuses present in a home are connected to a network and exchange data. A user may receive a high-quality service through the data exchange between the plurality of IoT apparatuses present in the home.

Such a case leads to an emerging need for a method for allowing the user to easily recognize a home appliance (for example, an air conditioner or a refrigerator) present in the home by using a camera included in the home appliance present in a travel space, and for controlling a function of the home appliance present in the home by using a single electronic apparatus.

### SUMMARY

According to an embodiment of the present disclosure, provided is an electronic apparatus including: a communication interface; a processor connected operatively to the communication interface; and a memory connected electrically to the processor and configured to store instructions and travel map information including identification information of a home appliance present in a travel space; wherein the instructions, when executed by the processor, thereby providing information corresponding to a user interface (UI) based on a captured image received through the communication interface, cause the electronic apparatus to perform various operations.

The instructions may cause the electronic apparatus to identify whether the home appliance is present in a first captured image based on the first captured image of the travel space being received through the communication interface.

The instructions may cause the electronic apparatus to acquire the identification information of the home appliance identified to be present based on the travel map information and the first captured image if the home appliance is identified to be present in the first captured image.

The instructions may cause the electronic apparatus to acquire information on function provided by the identified home appliance based on the acquired identification information.

The instructions may cause the electronic apparatus to identify information corresponding to the UI for providing a function of the identified home appliance together with the first captured image based on the acquired information on function.

The instructions may cause the electronic apparatus to transmit the information corresponding to the UI to a user terminal through the communication interface.

According to an embodiment of the present disclosure, provided is a control method of an electronic apparatus, the method including: determining whether a home appliance is present in a first captured image based on the first captured image of a travel space being received.

The method includes acquiring identification information of the home appliance identified to be present based on travel map information including the identification information of the home appliance present in the travel space and the first captured image if the home appliance is identified to be present in the first captured image.

The method includes acquiring information on function provided by the identified home appliance based on the acquired identification information.

The method includes identifying information corresponding to a user interface (UI) for providing a function of the identified home appliance together with the first captured image based on the acquired information on function.

The method includes transmitting the identified information corresponding to the UI to a user terminal.

According to an embodiment of the present disclosure, provided is a non-transitory computer-readable recording medium storing computer instructions that cause an electronic apparatus to perform an operation if executed by a processor of the electronic apparatus, wherein the operation includes determining whether a home appliance is present in a first captured image based on the first captured image of a travel space being received.

The operation includes acquiring identification information of the home appliance identified to be present based on travel map information including the identification information of the home appliance present in the travel space and the first captured image if the home appliance is identified to be present in the first captured image.

The operation includes acquiring information on function provided by the identified home appliance based on the acquired identification information.

The operation includes identifying information corresponding to a user interface (UI) for providing a function of the identified home appliance together with the first captured image based on the acquired information on function.

The operation includes transmitting the identified information corresponding to the UI to a user terminal.

### BRIEF DESCRIPTION OF THE DRAWINGS

FIG. 1 is a diagram for schematically describing a control method of an electronic apparatus according to an embodiment.

FIG. 2 is a block diagram showing components included in the electronic apparatus according to an embodiment.

FIG. 3 is a diagram for describing the control method of an electronic apparatus according to an embodiment.

FIG. 4 is a diagram for describing a method for identifying user interface (UI) information according to an embodiment.

FIG. 5 is a diagram for describing a method for providing a second captured image according to an embodiment.

FIG. 6 is a diagram for describing a method for providing the second captured image according to an embodiment.

FIG. 7 is a diagram for describing a method for providing the UI information according to an embodiment.

FIGS. 8A and 8B are diagrams for describing a method for controlling a robot based on user movement information according to an embodiment.

FIGS. 9A to 9C are diagrams for describing a method for identifying the UI information in a case where a plurality of cameras are included in a home appliance according to an embodiment.

FIG. 10 is a diagram for describing a method for providing a captured image corresponding to one of the plurality of home appliances according to an embodiment.

FIG. 11 is a diagram for describing a method for providing a user with the second captured image according to an embodiment.

FIG. 12 is a diagram for describing a method for providing the user with the second captured image according to an embodiment.

FIG. 13 is a block diagram showing specific components included in the electronic apparatus according to an embodiment.

### DETAILED DESCRIPTION

Hereinafter, the embodiments of the disclosure are described in detail with reference to the accompanying drawings.

Terms used in the specification are briefly described, and the disclosure is then described in detail.

General terms that are currently widely used are selected as terms used in embodiments of the disclosure in consideration of their functions in the disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the disclosure. Therefore, the terms used in the disclosure need to be defined on the basis of the meanings of the terms and the contents throughout the disclosure rather than simple names of the terms.

In the present disclosure, the expression such as “have”, “may have”, “include”, or “may include”, indicates the presence of a corresponding feature (for example, a numerical value, a function, an operation, or a component such as a part), and does not exclude the presence of an additional feature.

An expression such as “at least one of A or/and B” may indicate either “A or B”, or “both of A and B.”

Expressions such as “first” and “second,” used in the disclosure may indicate various components regardless of the sequence or importance of the components. The expression is used only to distinguish one component from another component, and does not limit the corresponding component.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by the processor (not shown) except for a “module” or a “˜er/or” that needs to be implemented by a specific hardware.

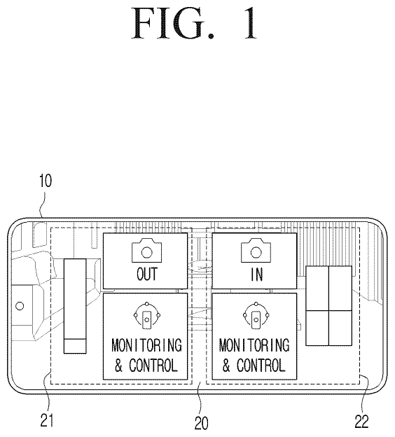

FIG. 1 is a diagram for schematically describing a control method of an electronic apparatus according to an embodiment.

Referring to FIG. 1, according to an embodiment, an electronic apparatus 100 may provide user interface (UI) information to a user through a user terminal 10 based on a captured image that is acquired by capturing a home interior. The UI information may refer to information related to a user interface and may include data used to generate the UI. The UI may be generated by the electronic apparatus or by a user terminal communicable with the electronic apparatus based on the UI information. The UI information may also be referred to as information corresponding to the UI.

For example, if the captured image of the home interior (or a travel space) is received, the electronic apparatus 100 may determine a home appliance included in the received captured image. The electronic apparatus 100 may identify information related to a function of the home appliance included in the captured image, and transmit a UI 20 including information related to the identified function to the user terminal 10.

For example, if an air conditioner and a refrigerator are present in the captured image, the electronic apparatus 100 may identify information related to a function of the air conditioner and information related to a function of the refrigerator. The electronic apparatus 100 may identify a guidance UI 21 for providing the function of the air conditioner based on the information related to the identified function of the air conditioner, and may identify a guidance UI 22 for providing the function of the refrigerator based on the information related to the identified function of the refrigerator. The electronic apparatus 100 may transmit the UI 20 including the identified guidance UIs 21 and 22 to the user terminal 10. In this case, the UI 20 may include an image acquired by capturing the travel space.

Hereinafter, various embodiments are described that allow the user to intuitively control a plurality of home appliances within the travel space by providing the user with a UI that provides the function of the home appliance present in the captured image together with the captured image, if the home appliance is included in the captured image.

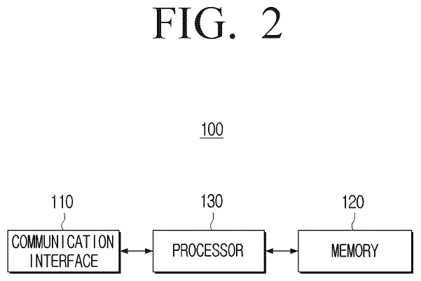

FIG. 2 is a block diagram showing components included in the electronic apparatus according to an embodiment.

Referring to FIG. 2, the electronic apparatus 100 may include a communication interface 110, a memory 120, and at least one processor 130.

The electronic apparatus 100 may be implemented as an apparatus that processes data such as a server and performs communication with an external apparatus according to an embodiment, and is not limited thereto. For example, the electronic apparatus 100 may be implemented as a cloud server that communicates with a plurality of internet of things (IoT) apparatuses, is not limited thereto, and may be implemented as any of various apparatuses such as a smart television (TV), a tablet, a monitor, a smart phone, a desktop computer, and a laptop computer. The electronic apparatus 100 according to an embodiment of the present disclosure is not limited to any of the above-described apparatuses, and may be implemented as the electronic apparatus 100 having two or more functions of the above-described apparatuses.

The external apparatus (not shown) may be implemented as an IoT apparatus installed in the home according to an embodiment, and is not limited thereto. For example, the IoT apparatus may be a different type of electronic apparatus that performs communication with the electronic apparatus 100 and is implemented as an oven, a microwave, an air conditioner, a washing machine, a TV, or a refrigerator, and is not limited thereto.

The external apparatus (not shown) may be implemented as the external apparatus (not shown) having two or more functions of the above-described apparatuses.

Meanwhile, the electronic apparatus 100 may communicate with the external apparatus (not shown) by using various methods. According to an embodiment, a communication module for performing the communication with the external apparatus (not shown) may be implemented in the same manner. For example, the electronic apparatus 100 may communicate with the external apparatus (not shown) by using a Bluetooth module.

The communication interface 110 may input and output various types of data. For example, the communication interface 110 may transmit and receive various types of data to and from the external apparatus (not shown) (for example, source apparatus), an external storage medium (for example, a universal serial bus (USB) memory), an external server (for example, web hard) through a communication method such as access point (AP)-based wireless fidelity (Wi-Fi, wireless local area network (LAN)), Bluetooth, Zigbee, wired/wireless local area network (LAN), wide area network (WAN), Ethernet, IEEE 1394, high definition multimedia interface (HDMI), universal serial bus (USB), mobile high-definition link (MHL), audio engineering society/European broadcasting union (AES/EBU) communication, optical communication, or coaxial communication.

For example, the communication interface 110 may include a Bluetooth low energy (BLE) module. The BLE refers to a Bluetooth technology that enables transmission and reception of low-power and low-capacity data in a 2.4 gigahertz (GHz) frequency band having a range of about 10 m. However, the present disclosure is not limited thereto, and the communication interface 110 may include a Wi-Fi communication module. That is, the communication interface 110 may include at least one of the Bluetooth low energy (BLE) module or the Wi-Fi communication module.

The memory 120 may store data required for the various embodiments. The memory 120 may be implemented as a memory embedded in the electronic apparatus 100 or as a memory detachable from the electronic apparatus 100 depending on a purpose of the data storage. For example, data for operating the electronic apparatus 100 may be stored in the memory embedded in the electronic apparatus 100, and data for expanding the electronic apparatus 100 may be stored in the memory detachable from the electronic apparatus 100.

Meanwhile, the memory embedded in the electronic apparatus 100 may be implemented as at least one of a volatile memory (e.g., a dynamic RAM (DRAM), a static RAM (SRAM), or a synchronous dynamic RAM (SDRAM)), or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)). In addition, the memory detachable from the electronic apparatus 100 may be implemented as a memory card (e.g., a compact flash (CF), a secure digital (SD), a micro secure digital (Micro-SD), a mini secure digital (Mini-SD), an extreme digital (xD), or a multi-media card (MMC)), or an external memory that may be connected to a universal serial bus (USB) port (e.g., a USB memory).

According to an embodiment, the memory 120 may store travel map information including identification information of each of at least one home appliance present in the travel space. Here, the identification information refers to information for identifying at least one home appliance present in a travel space, and for example, the identification information may include at least one of model information of the home appliance, an identifier of the home appliance, location information of the home appliance on the travel map, or function information (information on function) of the home appliance. The identification information may be determined based on an indicium on the home appliance, such as a barcode, quick response (QR) code, or the like or by analyzing an image captured of the home appliance.

Here, each home appliance present in a travel space may be in communication with the electronic apparatus 100 and may transmit and receive information through the communication interface 110. The identifier of the home appliance refers to unique information corresponding to each of at least one home appliance in the travel space. The electronic apparatus 100 may classify and recognize each of at least one home appliance based on identification information including the identifier of the home appliance, and transmit and receive information to and from at least one home appliance. The function information of the home appliance refers to information about a service provided by the home appliance. For example, the function information of the home appliance may include function information for providing an image by using a camera included in the home appliance. The function information may also be referred to as information on function. However, the present disclosure is not limited thereto.

At least one processor 130 (hereinafter, the processor) may be electrically connected to the communication interface 110 and the memory 120, and control overall operations of the electronic apparatus 100. The processor 130 may include one or more processors. In detail, the processor 130 may perform the operations of the electronic apparatus 100 according to the various embodiments of the present disclosure by executing at least one instruction stored in the memory 120.

According to an embodiment, the processor 130 may be implemented as a digital signal processor (DSP), a microprocessor, a graphics-processing unit (GPU), an artificial intelligence (AI) processor, a neural processing unit (NPU), a time controller (TCON), or the like. However, the processor 130 is not limited thereto, and may include at least one of a central processing unit (CPU), a micro controller unit (MCU), a micro processing unit (MPU), a controller, an application processor (AP), a communication processor (CP), or an advanced RISC (Reduced Instruction Set Computer) machine (ARM) processor, or may be defined by a relevant term. In addition, the processor 130 may be implemented as a system-on-chip (SoC) or a large scale integration (LSI), having a processing algorithm embedded therein, or may be implemented as an application specific integrated circuit (ASIC) or a field programmable gate array (FPGA).

According to an embodiment, the processor 130 may receive the image acquired by capturing the travel space from the external apparatus (not shown) through the communication interface 110. For example, the processor 130 may be in the communication with a robot (not shown) and receive the first captured image from the robot (not shown) through the communication interface 110. Here, the first captured image refers to the captured image acquired using the camera included in the robot (not shown).

According to an embodiment, the processor 130 may identify whether the home appliance is present based on the captured image received through the communication interface 110. For example, the processor 130 may identify whether the home appliance is present in the received first captured image if the first captured image of the travel space is received from the robot (not shown) through the communication interface 110. For example, the memory 120 may store a neural network model trained to identify an object included in the image (for example, the refrigerator or the air conditioner), and the processor 130 may input the first captured image received through the communication interface 110 into the trained neural network model to thus determine the presence of the home appliance present in the first captured image. However, the present disclosure is not limited thereto, and the processor 130 may also determine the presence of the object included in the first captured image by analyzing the first captured image using a predetermined algorithm.

According to an embodiment, the processor 130 may acquire identification information of the home appliance identified to be present in the captured image. For example, the processor 130 may acquire the identification information of the home appliance identified to be present based on the travel map information and the first captured image if the home appliance is identified to be present in the first captured image.

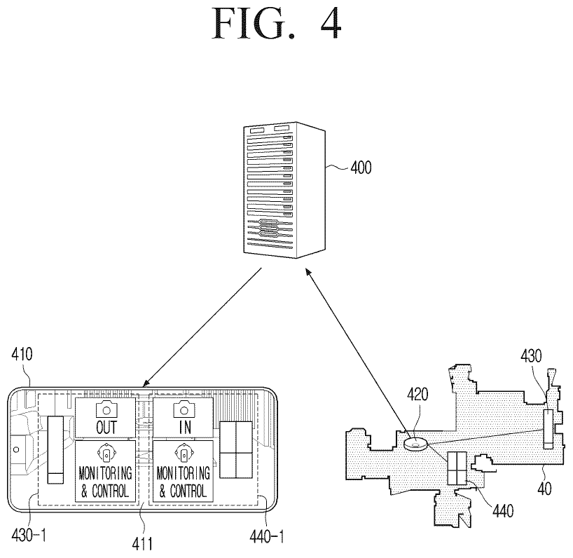

For example, if the home appliance is identified to be present in the first captured image, the processor 130 may identify the home appliance in the first captured image by using a location of the robot (not shown) that provides the first captured image, a location of the home appliance in the first captured image, and the travel map information, and acquire identification information of the identified home appliance. This configuration is described in detail with reference to FIG. 4.

According to an embodiment, the processor 130 may acquire function information provided by the identified home appliance based on the acquired identification information. For example, the identification information may include at least one of the model information, identifier, location information on the travel map, or function information of each of at least one home appliance present in the travel space. The processor 130 may acquire the identification information of the home appliance present in the first captured image from the identification information of at least one home appliance in the travel space stored in the memory 120, thereby acquiring the function information of the home appliance.

For example, it is assumed that the home appliance present in the first captured image is the air conditioner. The memory 120 may store identification information of the air conditioner present in the travel space, and the identification information of the air conditioner may include model information of the air conditioner, an identifier of the air conditioner, location information of the air conditioner on the travel map, or function information of the air conditioner (for example, an output mode of the air conditioner, power On/Off, or a function for providing an image by using a camera included in the air conditioner).

According to an embodiment, the processor 130 may identify the user interface (UI) information for providing the function of the identified home appliance together with the first captured image based on the acquired function information. For example, the processor 130 may identify a guidance UI corresponding to each of at least one function of the home appliance included in the first captured image, and based on this identification, the processor 130 may identify the UI information overlapping the guidance UI identified at the location of the home appliance in the first captured image. This configuration is described in detail with reference to FIG. 4.

According to an embodiment, the processor 130 may transmit the identified UI information to the user terminal through the communication interface 110. For example, the processor 130 may transmit the identified UI information to the user terminal if the UI information including the guidance UI corresponding to each of at least one function of the home appliance present in the first captured image is identified.

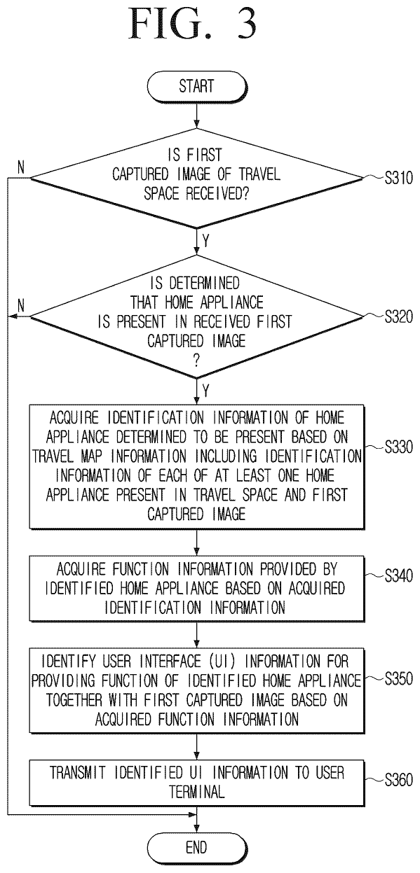

FIG. 3 is a flowchart for describing the control method of an electronic apparatus according to an embodiment.

Referring to FIG. 3, according to an embodiment, a control method may first include determining whether the first captured image of the travel space is received (S310).

Next, according to an embodiment, the control method may include determining whether the home appliance is present in the received first captured image (S320) if the first captured image of the travel space is received (S310: Y). For example, the processor 130 may receive the first captured image from the robot (not shown). The memory 120 may store the neural network model trained to identify the object included in the image, and the processor 130 may input the first captured image received through the communication interface 110 into the trained neural network model to thus identify whether the home appliance is present in the first captured image. Alternatively, for example, the processor 130 may determine the presence of the home appliance included in the first captured image by using the predetermined algorithm.

Next, according to an embodiment, the control method may include acquiring the identification information of the home appliance identified to be present based on the travel map information including the identification information of each of at least one home appliance present in the travel space and the first captured image (S330) if it is determined that the home appliance is present in the first captured image (S320: Y). For example, the processor 130 may input the first captured image into the trained neural network model, and acquire the identification information of the air conditioner based on the travel map information and the first captured image if it is determined that the air conditioner is included in the first captured image.

For example, the processor 130 may identify at least one air conditioner present in the travel map based on the travel map information, and identify the air conditioner present in the first captured image from the at least one air conditioner based on the location of the air conditioner in the first captured image. In this case, the location information of the robot (not shown) that provides the first captured image may be used. The processor 130 may identify the home appliance that matches the air conditioner included in the captured image on the travel map based on the location information of the robot (not shown) and the first captured image. If the home appliance that matches the air conditioner included in the captured image on the travel map is identified, the processor 130 may acquire the identification information of the identified home appliance from the identification information stored in the memory 120 as the identification information of the air conditioner included in the captured image, which is described in detail with reference to FIG. 4.

Next, according to an embodiment, the control method may include acquiring the function information provided by the identified home appliance based on the acquired identification information (S340). For example, the identification information may include the function information, and the processor 130 may acquire the function information included in the identification information of the air conditioner present in the first captured image.

Next, according to an embodiment, the control method may include identifying the user interface (UI) information for providing the function of the identified home appliance together with the first captured image based on the acquired function information (S350). For example, if the function information of the air conditioner is acquired, the processor 130 may identify the user interface (UI) information in which the guidance UI corresponding to each of at least one function of the air conditioner overlaps the first captured image based on the function information of the air conditioner. In this case, the guidance UI may be displayed at the location of the air conditioner in the first captured image.

Next, according to an embodiment, the control method may include transmitting the identified UI information to the user terminal (not shown) (S360).

In the above-described example, the electronic apparatus 100 may identify the home appliance in the home by using the captured image received from the robot (not shown), and provide the user with the user interface (UI) information for providing the function of the identified home appliance. Accordingly, a user convenience may be increased.

FIG. 4 is a diagram for describing a method for identifying the user interface (UI) information according to an embodiment.

Referring to FIG. 4, according to an embodiment, the processor 130 may acquire the identification information of the home appliance based on the first captured image acquired from a robot 420. Here, the first captured image refers to a captured image that is acquired using a camera included in the robot 420.

For example, the first captured image acquired using the camera included in the robot 420 may include a first object and a second object. The robot 420 may transmit the acquired first captured image to an electronic apparatus 400. If the first captured image is received from the robot 420 through the communication interface 110, the processor 130 may determine the presence of the first and second objects in the received first captured image.

For example, if the presence of the first and second objects in the first captured image is determined, the processor 130 may acquire identification information the first and second objects based on the travel map information stored in the memory 120.

For example, the processor 130 may identify locations of the first and second objects in the first captured image, respectively. Next, the processor 130 may identify the home appliances on the travel map that match the first object and the second object, respectively. In this case, the processor 130 may use location information of the robot 420. For example, the processor 130 may receive, from the robot 420 through the communication interface 110, the location information of the robot 420 and capture direction information of the camera at a time point at which the robot 420 acquires the captured image. The processor 130 may identify the home appliances on the travel map that match the first object and the second object included in the first captured image, respectively, as an air conditioner 430 and a refrigerator 440 based on the location information and the capture direction information of the robot 420, and acquire identification information of the air conditioner 430 and identification information of the refrigerator 440 as identification information of the first and second objects, respectively, based on the information stored in the memory 120.

For example, the processor 130 may identify the UI information for providing the function of the home appliance present in the first captured image based on the function information included in the acquired identification information.

For example, it is assumed that the air conditioner 430 is identified as being included on a left side of the first captured image and the refrigerator 440 is identified as being included on a right side thereof. The processor 130 may identify a guidance UI 430-1 for providing a function of the air conditioner 430 at a location of the air conditioner 430 in the first captured image based on the function information of the air conditioner 430 included in the identification information thereof, and identify a guidance UI 440-1 for providing a function of the refrigerator 440 at a location of the refrigerator 440 in the first captured image based on the function information of the refrigerator 440 included in the identification information thereof. The processor 130 may transmit UI information 411 including the identified plurality of guidance UIs 430-1 and 440-1 and the first captured image to a user terminal 410 through the communication interface 110. In this case, the plurality of guidance UIs 430-1 and 440-1 may be provided to the user by overlapping the first captured image.

In the above-described example, if the home appliance is included in the captured image acquired while the robot 420 travels, the electronic apparatus 400 may provide the user with the UI for providing the function of the home appliance included in the captured image, together with the captured image. Accordingly, the user may freely control the plurality of home appliances within the travel space by using the user terminal, and thus be provided with improved overall usability of the electronic apparatus. In addition, the user may manipulate the home appliance based on the captured image acquired by using the robot 420, and thus manipulate the home appliance more intuitively.

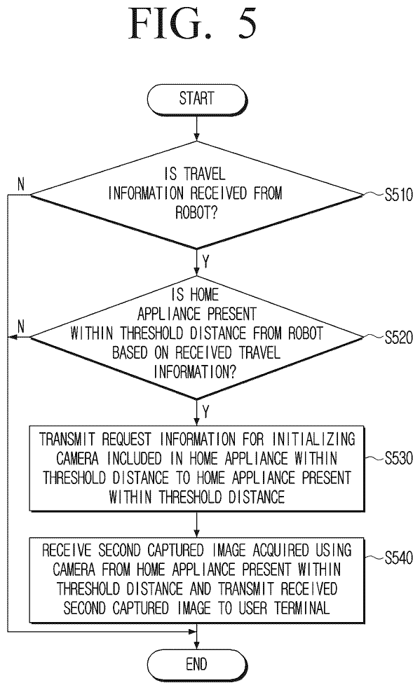

FIG. 5 is a diagram for describing a method for providing a second captured image according to an embodiment.

Referring to FIG. 5, according to an embodiment, the control method may first include determining whether the travel information is received from the robot (S510). Here, the travel information may include the location information of the robot, moving direction information of the robot, and moving speed information of the robot. For example, the processor 130 may receive, from the robot, the travel information of the robot together with the first captured image. In this case, the travel information of the robot may include time information corresponding to a time point of acquiring the first captured image, the location information of the robot that corresponds to the time point of acquiring the first captured image, the moving direction information of the robot, or the moving speed information of the robot.

Next, according to an embodiment, the control method may include determining whether the home appliance is present within a threshold distance from the robot based on the received travel information (S520) if the travel information is received from the robot (S510: Y). For example, the processor 130 may identify the home appliance present within the threshold distance from the robot based on the travel map information stored in the memory 120 and the location information of the robot. In this case, the processor 130 may also identify the home appliance present within the threshold distance from a travel path of the robot based on the moving direction information of the robot, from the home appliances present within the threshold distance from the robot.

Meanwhile, for example, the processor 130 may calculate the threshold distance. If the camera is included in the home appliance within the travel space, the processor 130 may calculate the threshold distance based on a time required for initializing the camera, a predicted time until the home appliance is exposed to the camera included in the robot, and maximum speed information of the robot. For example, if the robot travels at a maximum speed, the processor 130 may calculate the threshold distance as a value greater than a first distance at which the time required for initializing the camera is equal to the predicted time until the home appliance is exposed to the camera included in the robot. The processor 130 may store the calculated threshold distance in the memory 120.

The camera included in the home appliance requires time for the initialization. If the camera initialization is completed after the home appliance is exposed in the first captured image, the processor 130 may have difficulty in providing the captured image included in the home appliance to the user, as described below. Accordingly, to provide proper functionality to the user, the camera included in the home appliance is initialized before the home appliance is exposed in the first captured image.

Next, according to an embodiment, the control method may include transmitting request information for initializing the camera included in the home appliance within the threshold distance to the home appliance present within the threshold distance (S530) if the home appliance is present within the threshold distance from the robot based on the received travel information (S520: Y). For example, the processor 130 may identify whether the home appliance includes the camera based on the identification information of the home appliance if the home appliance is present within the threshold distance. The processor 130 may transmit request information for obtaining a second capture image by using a camera included in the home appliance to the home appliance through the communication interface 110 based on the home appliance being identified to be present within the threshold distance. The processor 130 may transmit the request information for initializing the camera included in the home appliance to the home appliance through the communication interface 110 if it is determined that the home appliance within the threshold distance includes the camera. The home appliance may perform the initialization of the camera included in the home appliance if the request information is received from the electronic apparatus 100.

Next, according to an embodiment, the control method may include receiving the second captured image acquired using the camera from the home appliance present within the threshold distance and transmit the received second captured image to the user terminal (S540). Here, the second captured image refers to a captured image that is acquired using the camera included in the home appliance. For example, in case of a refrigerator including the camera, the second captured image may be acquired using the camera included in the refrigerator. For example, the processor 130 may receive the second captured image acquired using the camera included in the refrigerator through the communication interface 110 if the refrigerator is present within the threshold distance from the robot. The processor 130 may transmit the received second captured image to the user terminal through the communication interface 110.

In the above-described example, the electronic apparatus 100 may determine the home appliance present within the threshold distance from the robot based on the travel information. The electronic apparatus 100 may provide the user with the captured image acquired using the camera included in the home appliance identified to be present. This configuration may increase user satisfaction. Meanwhile, the electronic apparatus 100 may control the home appliance to acquire the second captured image without a problem by initializing the camera included in the home appliance present within the threshold distance.

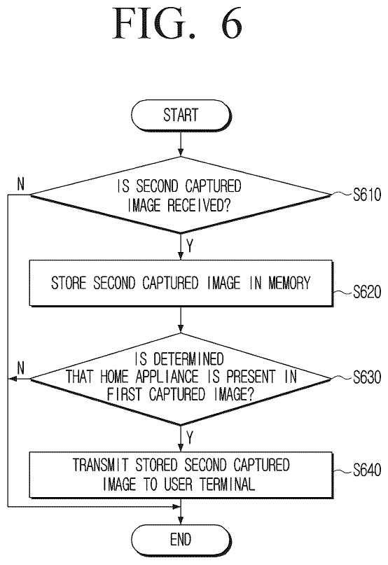

FIG. 6 is a diagram for describing a method for providing the second captured image according to an embodiment.

Referring to FIG. 6, according to an embodiment, the control method may first include determining whether the second captured image is received (S610). For example, the processor 130 may receive the second captured image from the home appliance within the travel space through the communication interface 110. Here, the second captured image refers to the captured image acquired using the camera included in the home appliance. Meanwhile, for example, the processor 130 may receive the second captured image from the home appliance present within the threshold distance from the robot. For example, the processor 130 may receive the second captured image from the refrigerator present within the threshold distance from the robot through the communication interface 110.

Next, according to an embodiment, the control method may include storing the second captured image in the memory 120 (S620) if the second captured image is received (S610: Y). For example, the processor 130 may buffer the received second captured image if the second captured image is received from the home appliance present within the threshold distance from the robot. For example, the processor 130 may buffer the second captured image received from the refrigerator in the memory 120.

Next, according to an embodiment, the control method may include determining whether the home appliance is present in the first captured image (S630).

Next, according to an embodiment, the control method may include transmitting the stored second captured image to the user terminal (S640) if the home appliance is present in the first captured image (S630: Y). For example, if it is determined that the refrigerator is included in the first captured image received from the robot, the processor 130 may transmit the second captured image corresponding to the refrigerator as the captured image stored in the memory 120 to the user terminal through the communication interface 110.

According to an embodiment, the processor 130 may identify UI information for providing the second captured image corresponding to the home appliance if the home appliance is present in the first captured image. If the identified UI information is transmitted to the user terminal and a user input for playing the second captured image is received from the user terminal, the processor 130 may transmit the second captured image corresponding to the home appliance to the user terminal through the communication interface 110.

In the above-described example, if the home appliance is present within the threshold distance from the robot, the electronic apparatus 100 may receive and buffer the second captured image from the home appliance before the home appliance is exposed in the first captured image captured by the robot. Accordingly, if the home appliance is exposed in the first captured image, the second captured image may be transmitted directly to the user terminal without any separate loading time.

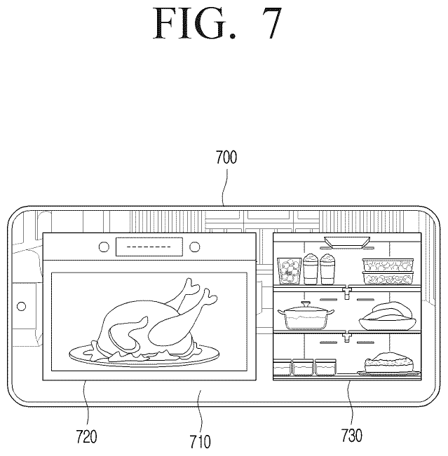

FIG. 7 is a diagram for describing a method for providing the UI information according to an embodiment.

According to an embodiment, the processor 130 may transmit the UI information including the first and second captured images to the user terminal (700).

For example, the processor 130 may transmit UI information 710 in which the second captured image overlaps the location of the home appliance present in the first captured image to the user terminal through the communication interface 110. For example, the overlapped UI information 710 may include the second captured image corresponding to each of at least one home appliance present in the first captured image, and also include an exterior image of the home appliance corresponding to each of the second captured images.

For example, it is assumed that an oven and the refrigerator are present in the first captured image. If the oven is present on a relatively left side of the first captured image, the processor 130 may identify the UI information 710 in which a second captured image 720 (or the second captured image corresponding to the oven) received from the oven overlaps a location of the oven in the first captured image. In this case, the second captured image 720 corresponding to the oven may overlap the first captured image together with an exterior image of the oven.

In addition, if the refrigerator is present on a relatively right side of the first captured image, the processor 130 may identify the UI information 710 in which the second captured image 730 (or the second captured image corresponding to the refrigerator) received from the refrigerator overlaps the location of the refrigerator in the first captured image. In this case, a second captured image 730 corresponding to the refrigerator may overlap the first captured image together with the exterior image of the refrigerator. The processor 130 may transmit the UI information 710, in which the second captured image 720 corresponding to the oven and the second captured image 730 corresponding to the refrigerator respectively overlap the locations of the home appliances present in the first captured image, to a user terminal 700 through the communication interface 110.

Meanwhile, according to an embodiment, the processor 130 may transmit the UI information including the first and second captured images to the user terminal 700 based on the user input. For example, the processor 130 may transmit the UI information 710 including the second captured image overlapping the first captured image to the user terminal if the processor 130 receives, from the user terminal 700, a user input for displaying the second captured image corresponding to at least one home appliance included in the first captured image.

For example, if the first captured image includes a plurality of home appliances, the processor 130 may display the second captured image corresponding to any one of the plurality of home appliances present in the first captured image. For example, if the user input for displaying the second captured image corresponding to the oven is received, the processor 130 may identify the UI information in which only the second captured image corresponding to the oven overlaps the location of the oven among the plurality of home appliances present in the first captured image and transmit the same to the user terminal.

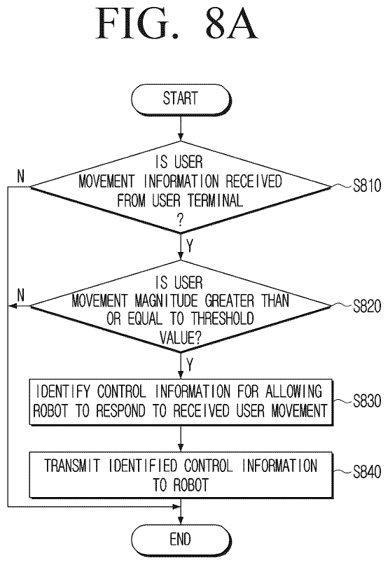

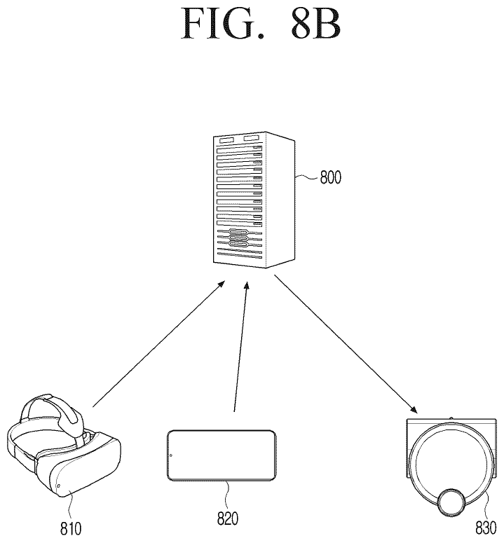

FIGS. 8A and 8B are diagrams for describing a method for controlling the robot based on user movement information according to an embodiment.

First, referring to FIG. 8A, according to an embodiment, the control method may include determining whether the user movement information is received from the user terminal (S810). Here, the user movement information refers to direction rotation information of the user terminal detected using a motion detection sensor (for example, a gyro sensor or an acceleration sensor) included in the user terminal. For example, the user movement information may include at least one of the horizontal rotation angle or vertical rotation angle of the user terminal. Meanwhile, as shown in FIG. 8B, for example, the user terminal may be implemented as at least one of a smartphone or a virtual reality (VR) apparatus.

Next, according to an embodiment, the control method may include determining whether a user movement magnitude is greater than or equal to a threshold value based on the received information (S820) if the user movement information is received from the user terminal (S810: Y).

Next, according to an embodiment, the control method may include identifying control information for allowing a robot to respond to a received user movement (S830) if the user movement magnitude is determined to be greater than or equal to the threshold value (S820: Y). For example, the processor identifies control information for the robot to correspond to the user movement based on identifying the user movement magnitude being greater than or equal to the threshold value. For example, the processor 130 may identify the control information for rotating a robot head by substantially 30° in a horizontal direction if it is determined that the user head rotates by substantially 30° in the horizontal direction based on the received user input (e.g., the user rotates the user head by substantially 30° from the left to the right).

Next, according to an embodiment, the control method may include transmitting the identified control information to the robot (S840).

Referring to FIG. 8B, according to an embodiment, an electronic apparatus 800 may control a robot 830 based on the user movement information received from a user terminal 810 or 820.

For example, if the user turns the user head by substantially 30° from the left to the right, the user terminal 810 or 820 may identify the corresponding user movement information and transmit the same to the electronic apparatus 800. The processor 130 may identify the control information for rotating the robot head by substantially 30° in the horizontal direction based on the received information if the user movement information indicating that the user head rotates by substantially 30° in the horizontal direction (or from the left to the right) is received from the user terminal 810 or 820. The processor 130 may transmit the identified control information to the robot 830 through the communication interface 110, and the robot 830 may control a driving unit of the robot 830 to rotate the robot head by substantially 30° in the horizontal direction based on the received control information.

Alternatively, for example, if the user rotates the user head by substantially 30° from downward to upward (or, if a user gaze relatively directed to a floor surface turns toward the sky), the user terminal 810 or 820 may identify the corresponding user movement information and transmit the same to the electronic apparatus 800. If the user movement information indicating that the user rotates the user head by substantially 30° in a vertical direction (or from downward to upward) is received from the user terminal 810 or 820, the processor 130 may identify the control information for rotating the robot head by substantially 30° in the vertical direction based on the received information. The processor 130 may transmit the identified control information to the robot 830 through the communication interface 110, and the robot 830 may control the driving unit of the robot 830 to rotate the robot head by substantially 30° in the vertical direction based on the received control information.

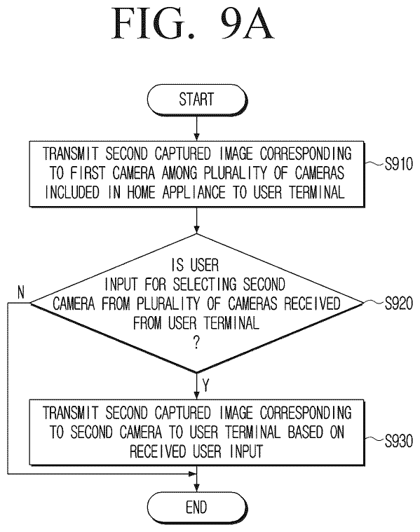

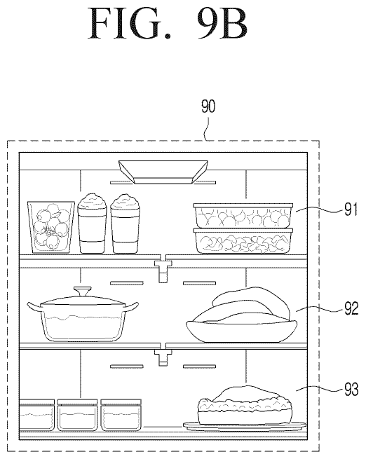

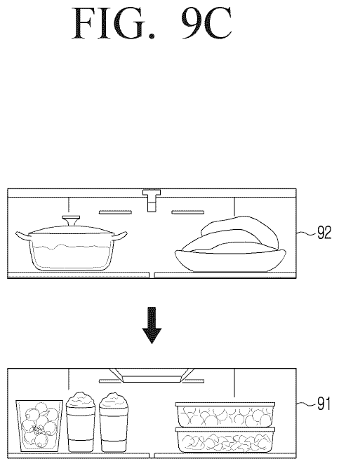

FIGS. 9A to 9C are diagrams for describing a method for identifying the UI information in a case where a plurality of cameras are included in the home appliance according to an embodiment.

First, referring to FIG. 9A, according to an embodiment, the control method may include transmitting the second captured image corresponding to a first camera among the plurality of cameras included in the home appliance to the user terminal (S910). For example, it is assumed that a plurality of cameras are included in at least one home appliance (for example, the refrigerator) present in the first captured image acquired from the robot. If the refrigerator is present in the first captured image, the processor 130 may receive, from the refrigerator, the second captured image corresponding to the first camera among the plurality of cameras included in the refrigerator, overlap the second captured image on the first captured image, and transmit the same to the user terminal.

Alternatively, for example, the processor 130 may overlap the second captured image on the first captured image based on the user input and transmit the same to the user terminal if the user input for displaying the second captured image corresponding to the first camera among the plurality of cameras included in the refrigerator is received from the user terminal.

Next, according to an embodiment, the control method may include determining whether the user input for selecting a second camera from the plurality of cameras is received from the user terminal (S920). For example, it is assumed that the second captured image corresponding to the first camera among the plurality of cameras corresponding to the refrigerator is displayed. The processor 130 may identify whether the user input for selecting the second camera different from the first camera from the plurality of cameras included in the refrigerator is received from the user terminal.

Next, according to an embodiment, the control method may include transmitting the second captured image corresponding to the second camera to the user terminal based on the received user input (S930) if the user input for selecting the second camera from the plurality of cameras is received (S920: Y).

For example, the processor 130 may receive the user input for selecting the second camera from the plurality of cameras included in the refrigerator. For example, the processor 130 may receive, from the user, a user input for changing the currently provided second captured image (the second captured image corresponding to the first camera) to the second captured image corresponding to the second camera, and based thereon, the processor 130 may receive the second captured image corresponding to the second camera from the refrigerator.

Alternatively, for example, the processor 130 may transmit the second captured image corresponding to the second camera to the user terminal based on the user movement information. For example, it is assumed that the second camera is disposed relatively higher than the first camera in the refrigerator. If the user movement information indicating that the user head rotates from downward to upward by a predetermined value or more is received from the user terminal, the processor 130 may identify the information as the user input for selecting the second camera from the plurality of cameras included in the refrigerator. Next, the processor 130 may receive, from the refrigerator, the second captured image corresponding to the second camera located relatively higher based thereon and transmit the same to the user terminal through the communication interface 110.

Meanwhile, according to an embodiment, the processor 130 may store the second captured image corresponding to each of the plurality of cameras included in the home appliance in the memory 120. For example, if it is determined that the refrigerator is disposed within the threshold distance from the robot, the processor 130 may receive, from the refrigerator, the second captured image corresponding to each of the plurality of cameras included in the refrigerator and store the same in the memory 120. If the user input for selecting the second camera from the plurality of cameras included in the refrigerator is received from the user terminal through the communication interface 110, the processor 130 may transmit the second captured image corresponding to the second camera among the second captured images stored in the memory 120 to the user terminal.

Accordingly, the electronic apparatus 100 may provide the second captured image to the user immediately without any separate loading time even if the user input for changing the camera included in the home appliance is received, thereby improving the user satisfaction.

Referring to FIGS. 9B and 9C, according to an embodiment, the processor 130 may identify the UI information included in the second captured image corresponding to one of the plurality of cameras based on the user input if the home appliance present in the first captured image includes the plurality of cameras.

For example, as shown in FIG. 9B, a refrigerator 90 may include a plurality of cameras and the second captured images 91 to 93 respectively corresponding to the plurality of cameras. For example, it is assumed that the user is provided with a UI including a second captured image 92 corresponding to the first camera among the plurality of cameras corresponding to the refrigerator. The processor 130 may receive, from the user, a user input for displaying the second captured image 91 corresponding to the second camera. For example, the processor 130 may receive, from the user terminal, the user movement information indicating that the user head rotates from downward to upward by the predetermined value or more. As shown in FIG. 9C, the processor 130 may identify the UI information for changing the second captured image provided to the user to the second captured image 91 corresponding to the second camera based on the received user movement information.

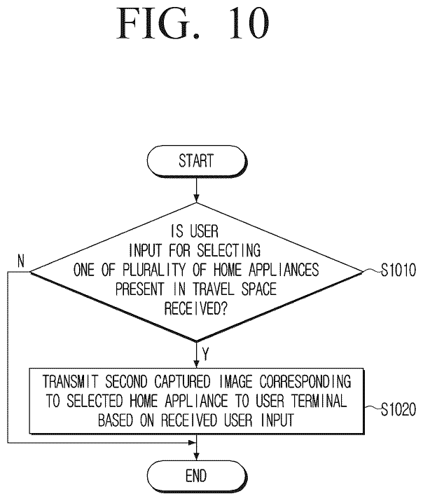

FIG. 10 is a diagram for describing a method for providing the captured image corresponding to one of the plurality of home appliances according to an embodiment.

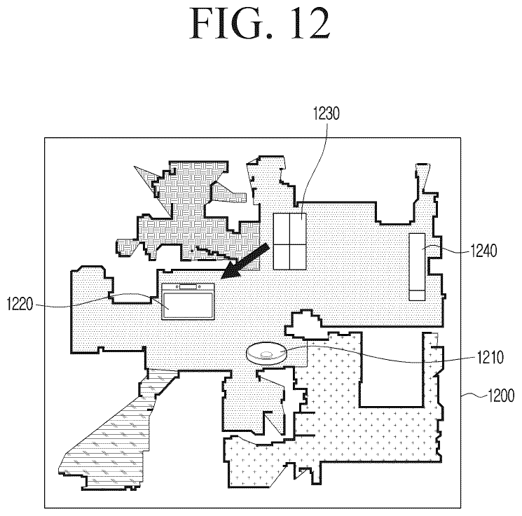

Referring to FIG. 10, according to an embodiment, the control method may first include determining whether a user input for selecting one of the plurality of home appliances present in the travel space is received (S1010). For example, as shown in FIG. 12, it is assumed that a plurality of home appliances 1220 to 1240 are present in a travel space 1200. The processor 130 may receive a user input for selecting one of the plurality of home appliances 1220 to 1240 from the user terminal through the communication interface 110.

For example, it is assumed that the user is provided with the UI information including the second captured image corresponding to the current refrigerator 1230. That is, it is assumed that the refrigerator 1230 is included in the first captured image acquired using a camera included in the robot 1210. The processor 130 may receive a user input for selecting the oven 1220 present on a left side relatively in a capture direction of the camera included in the robot 1210 from the user terminal through the communication interface 110. For example, the processor 130 may receive, from the user terminal, the user movement information indicating that the user head rotates by the predetermined value or more in the horizontal direction (or, from the left to the right), and identify the user input for selecting the oven 1220 from the plurality of home appliances present in the travel space based on the received user movement information and the travel map information.

However, the present disclosure is not limited thereto. For example, the processor 130 may receive, from the user terminal, a selection input for selecting the oven from the plurality of home appliances.

Next, according to an embodiment, the control method may include transmitting the second captured image corresponding to a selected home appliance to the user terminal based on the received user input (S1020) if the user input for selecting one of the plurality of home appliances is received (S1010: Y).

For example, the processor 130 may transmit the second captured image corresponding to the selected home appliance to the user terminal based on receiving information on a selection of one of the plurality of home appliances present in the travel space through the communication interface 110. For example, as shown in FIG. 12, if the plurality of home appliances are present in the travel space and the user input for selecting the oven 1220 is received, the processor 130 may receive the second captured image corresponding to the oven 1220 from the oven 1220 based on the received user input. In this case, the capture direction of the camera included in the robot 1210 may also be changed to include the oven 1220 in the first captured image based on the user input for selecting the oven 1220. The processor 130 may identify the UI information for overlapping the received second captured image corresponding to the oven 1220 on the first captured image and transmit the same to the user terminal.

In the above-described example, the electronic apparatus 100 may provide the second captured image corresponding to a home appliance desired by the user, and allow the user to view the second captured image corresponding to the home appliance desired by the user through a simple manipulation. This configuration may improve the user satisfaction.

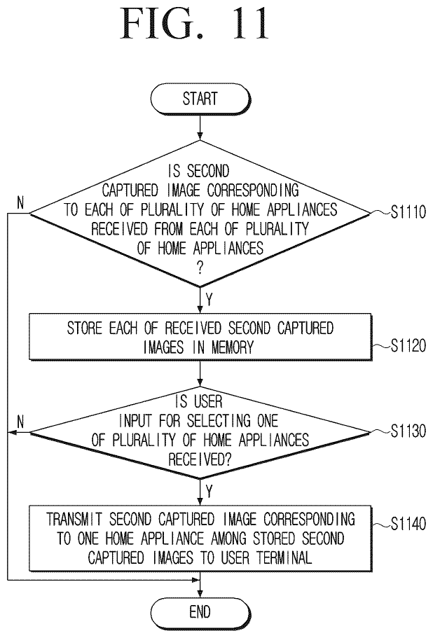

FIG. 11 is a diagram for describing a method for providing the user with the second captured image according to an embodiment.

Referring to FIG. 11, according to an embodiment, the control method may first include determining whether the second captured image corresponding to each of the plurality of home appliances is received from each of the plurality of home appliances (S1110). For example, the processor 130 may identify the home appliance including the camera from the plurality of home appliances present in the travel space and transmit a signal for requesting the second captured image corresponding to each home appliance including the camera.

Next, according to an embodiment, the control method may include storing each of the received second captured images in the memory 120 (S1120) if the second captured images respectively corresponding to the plurality of home appliances are received (S1110: Y). For example, the processor 130 may store the received second captured images in the memory 120, based on receiving the second captured image corresponding to each of the plurality of home appliances from the each of the plurality of home appliances. For example, the processor 130 may transmit the signal for requesting the second captured image corresponding to each home appliance including the camera to each home appliance, and based thereon, the processor 130 may receive the second captured image from the home appliance including the camera. The processor 130 may store (or buffer) the second captured image corresponding to each of the plurality of home appliances in the memory 120.

Next, according to an embodiment, the control method may include determining whether the user input for selecting one of the plurality of home appliances is received (S1130). For example, as shown in FIG. 12, it is assumed that the plurality of home appliances 1220 to 1240 are present in the travel space 1200. The processor 130 may receive the user input for selecting the oven 1220 from the plurality of home appliances 1220 to 1240 from the user terminal through the communication interface 110.

Next, according to an embodiment, the control method may include transmitting the second captured image corresponding to one home appliance among the stored second captured images to the user terminal (S1140) if the user input for selecting one of the plurality of home appliances is received (S1130: Y). For example, The processor 130 may transmit the received second captured image corresponding to one home appliance among the stored second captured images to the user terminal based on receiving the information on the selection of one of the plurality of home appliances is received. For example, if the user input for selecting the oven 1220 from the plurality of home appliances is received, the processor 130 may identify the second captured image corresponding to the oven 1220 from the second captured images respectively corresponding to the plurality of home appliances stored in the memory 120, and transmit the same to the user terminal. For example, the processor 130 may identify the UI information including the second captured image corresponding to the oven 1220 stored in the memory 120 and the second captured image received in real time from the oven 1220, and transmit the same to the user terminal.

In the above-described example, the electronic apparatus 100 may buffer the second captured image corresponding to each of the plurality of home appliances present in the travel space, and may provide the second captured image immediately without any separate loading time if the user input is received. This configuration may improve the user satisfaction and the usability.

However, the present disclosure is not limited thereto, and according to an embodiment, the processor 130 may receive and store the second captured image corresponding to the home appliance present within the threshold distance from the robot among the plurality of home appliances in the travel space. For example, as shown in FIG. 12, if the home appliances present within the threshold distance from the robot 1210 are the refrigerator 1230 and the oven 1220, the processor 130 may receive the second captured images corresponding to the refrigerator 1230 and the oven 1220 and store the second captured images in the memory 120.

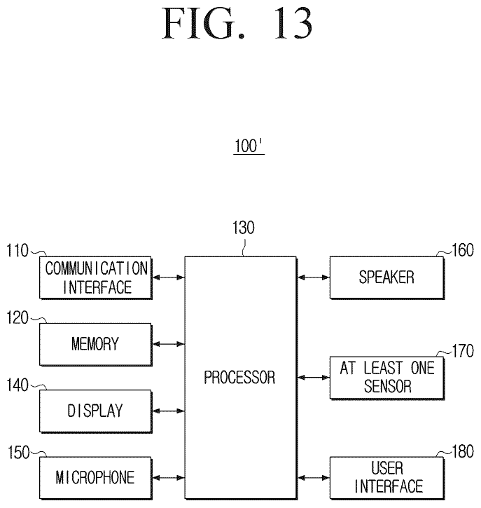

FIG. 13 is a block diagram showing specific configuration components included in the electronic apparatus according to an embodiment.

Referring to FIG. 13, an electronic apparatus 100′ may include the communication interface 110, the memory 120, at least one processor 130, a display 140, a microphone 150, a speaker 160, at least one sensor 170, and a user interface 180. Among the configurations shown in FIG. 13, a detailed description of the configurations that overlap with the configurations shown in FIG. 2 is omitted.

The display 140 may be implemented as a display including a self-luminous element or a display including a non-luminous element and a backlight. For example, the display 140 may be implemented as various types of displays such as a liquid crystal display (LCD), an organic light emitting diode (OLED) display, a light-emitting diode (LED) display, a micro LED display, a mini LED display, a plasma display panel (PDP), a quantum dot (QD) display, and a quantum dot light-emitting diode (QLED) display. The display 140 may include a driving circuit, a backlight unit, and the like, which may be implemented in a form such as an amorphous silicon thin film transistor (a-si TFT), a low temperature poly silicon (LTPS) TFT, or an organic TFT (OTFT). Meanwhile, the display 140 may be implemented as a touchscreen combined with a touch sensor, a flexible display, a rollable display, a three-dimensional (3D) display, a display in which a plurality of display modules are physically connected to each other, or the like. The processor 130 may control the display 140 to output an output image acquired according to the various embodiments described above. Here, the output image may be a high-resolution image of 4K or 8K or higher.

Meanwhile, according to another embodiment, the electronic apparatus 100′ may not include the display 140. The electronic apparatus 100′ may be connected to an external display apparatus and may transmit images or content stored in the electronic apparatus 100′ to the external display apparatus. In detail, the electronic apparatus 100′ may transmit the images or content to the external display apparatus together with a control signal for controlling the images or content to be displayed on the external display apparatus.

Here, the external display apparatus may be connected to the electronic apparatus 100′ through the communication interface 110 or an input/output interface (not shown). For example, the electronic apparatus 100′ may not include a display, such as a set-top box (STB). In addition, the electronic apparatus 100′ may include only a small display capable of displaying simple information, such as text information. Here, the electronic apparatus 100′ may transmit the images or content to the external display apparatus through the communication interface 110, in a wired or wireless manner, or through the input/output interface (not shown).

The microphone 150 may indicate a module that acquires sound and converts the same into an electric signal, and may be a condenser microphone, a ribbon microphone, a moving coil microphone, a piezoelectric element microphone, a carbon microphone, a micro electro mechanical system (MEMS) microphone. In addition, the microphone 150 may be implemented in an omnidirectional, bidirectional, unidirectional, subcardioid, supercardioid, or hypercardioid manner.

The speaker 160 may include a tweeter for reproducing high-frequency sounds, a midrange for reproducing medium-frequency sounds, a woofer for reproducing low-frequency sounds, a subwoofer for reproducing ultra-low-frequency sounds, an enclosure for controlling resonance, a crossover network for dividing a frequency of an electric signal input into the speaker into bands, or the like.

The speaker 160 may output an audio signal to the outside of the electronic apparatus 100′. The speaker 160 may output multimedia reproduction, recording reproduction, various notification sounds, voice messages, or the like. The electronic apparatus 100′ may include an audio output apparatus such as the speaker 160, and may include an output apparatus such as an audio output terminal. In particular, the speaker 160 may provide acquired information, information processed and produced based on the acquired information, a response result to a user voice, or an operation result, or the like in a voice form.

At least one sensor 170 (hereinafter referred to as the sensor) may include a plurality of sensors of various types. The sensor 170 may measure a physical quantity or detect an operating state of the electronic apparatus 100′, and convert the measured or detected information into the electrical signal. The sensor 170 may include a camera, and the camera may include a lens that focuses visible light or other optical signals reflected from an object and received onto an image sensor, and the image sensor capable of detecting visible light or other optical signals. Here, the image sensor may include a two-dimensional (2D) pixel array divided into a plurality of pixels. Alternatively, at least one sensor 170 may include a temperature sensor or an infrared sensor.

The user interface 180 is a component for enabling the electronic apparatus 100′ to perform interaction with the user. For example, the user interface 180 may include at least one of a touch sensor, a motion sensor, a button, a jog dial, a switch, a microphone, or a speaker, and is not limited thereto.

In the above-described example, if the home appliance is included in the captured image acquired while the robot travels, the electronic apparatus 100′ may provide the user with the UI for providing the function of the home appliance included in the captured image together with the captured image. Accordingly, the user may freely control the plurality of home appliances within the travel space by using the user terminal, and thus be provided with the improved overall usability of the electronic apparatus. In addition, the user may manipulate the home appliance based on the captured image acquired from the robot, and thus manipulate the home appliance more intuitively.

Meanwhile, the methods according to the various embodiments of the disclosure described above may be implemented in the form of an application capable of being installed on a conventional electronic apparatus. Alternatively, the methods according to the various embodiments of the disclosure described above may be performed using a deep learning-based trained neural network (or deep trained neural network), that is, the learning network model. In addition, the methods according to the various embodiments of the disclosure described above may be implemented only by software upgrade or hardware upgrade of the conventional electronic apparatus. In addition, the various embodiments of the disclosure described above may be performed through an embedded server included in the electronic apparatus, or an external server of the electronic apparatus.

Meanwhile, according to an embodiment of the disclosure, the various embodiments described above may be implemented in software including an instruction stored on a machine-readable storage medium (for example, a computer-readable storage medium). A machine may be an apparatus that invokes the stored instruction from a storage medium, may be operated based on the invoked instruction, and may include the display apparatus (e.g., display apparatus A) according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term “non-transitory” refer to that the storage medium is tangible without including a signal, and does not distinguish whether data are semi-permanently or temporarily stored on the storage medium.

In addition, according to an embodiment, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™. In case of the online distribution, at least a part of the computer program product may be at least temporarily stored or temporarily provided on a storage medium such as the memory of a manufacturer server, an application store server, or a relay server.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
a communication interface;
a processor connected operatively to the communication interface; and
a memory connected electrically to the processor and configured to store instructions and travel map information including identification information of a home appliance present in a travel space, wherein the instructions, when executed by the processor, thereby providing information corresponding to a user interface (UI) based on a captured image received through the communication interface, cause the electronic apparatus to:
identify whether the home appliance is present in a first captured image based on the first captured image of the travel space being received through the communication interface,
acquire the identification information of the home appliance identified to be present based on the travel map information and the first captured image if the home appliance is identified to be present in the first captured image,
acquire information on function provided by the identified home appliance based on the acquired identification information,
identify information corresponding to the UI for providing a function of the identified home appliance together with the first captured image based on the acquired information on function, and
transmit the information corresponding to the UI to a user terminal through the communication interface.

2. The electronic apparatus as claimed in claim 1, wherein the instructions, when executed by the processor, cause the electronic apparatus to:
identify whether the home appliance is present within a threshold distance from a robot based on travel information received from the robot through the communication interface,
transmit request information for obtaining a second captured image by using a camera included in the home appliance to the home appliance through the communication interface based on the home appliance being identified to be present within the threshold distance, and
through the communication interface, receive the second captured image acquired using the camera and transmit the received second captured image to the user terminal.

3. The electronic apparatus as claimed in claim 2, wherein the instructions are configured to, when executed by the processor, cause the electronic apparatus to
store the second captured image in the memory based on the second captured image being received, and
transmit the stored second captured image to the user terminal based on the home appliance being identified to be present in the first captured image.

4. The electronic apparatus as claimed in claim 2, wherein the instructions are configured to, when executed by the processor, cause the electronic apparatus to transmit the information corresponding to the UI, in which the second captured image overlaps a location of the home appliance present in the first captured image, to the user terminal through the communication interface.

5. The electronic apparatus as claimed in claim 1, wherein the instructions are configured to, when executed by the processor, cause the electronic apparatus to:
receive user movement information from the user terminal through the communication interface,
identify whether a user movement magnitude is greater than or equal to a threshold value based on the received user movement information,
identify control information for a robot to correspond to user movement based on identifying the user movement magnitude being greater than or equal to the threshold value, and
transmit the identified control information to the robot through the communication interface.

6. The electronic apparatus as claimed in claim 2, wherein the instructions are configured to, when executed by the processor, cause the electronic apparatus to:
transmit the second captured image corresponding to a first camera among a plurality of cameras included in the home appliance to the user terminal, and
transmit the second captured image corresponding to a second camera to the user terminal based on receiving information on a selection of the second camera from the plurality of cameras from the user terminal.

7. The electronic apparatus as claimed in claim 6, wherein the instructions are configured to, when executed by the processor, cause the electronic apparatus to transmit the second captured image corresponding to the second camera to the user terminal based on receiving user movement information for selecting the second camera.

8. The electronic apparatus as claimed in claim 6, wherein the instructions are configured to, when executed by the processor, cause the electronic apparatus to:
store the second captured image corresponding to each of the plurality of cameras included in the home appliance in the memory, and
transmit the second captured image corresponding to the second camera among the stored second captured images to the user terminal based on receiving information on a user input for selecting the second camera from the plurality of cameras from the user terminal through the communication interface.

9. The electronic apparatus as claimed in claim 2, wherein the instructions are configured to, when executed by the processor, cause the electronic apparatus to transmit the second captured image corresponding to a selected home appliance to the user terminal based on receiving information on a selection of one of the plurality of home appliances present in the travel space through the communication interface.

10. The electronic apparatus as claimed in claim 9, wherein the instructions are configured to, when executed by the processor, cause the electronic apparatus to:
based on receiving the second captured image corresponding to each of a plurality of home appliances from the each of the plurality of home appliances, store the received second captured images in the memory, and
transmit the received second captured image corresponding to one home appliance among the stored second captured images to the user terminal based on receiving the information on the selection of one of the plurality of home appliances.

11. A control method of an electronic apparatus, the method comprising:
determining whether a home appliance is present in a first captured image based on the first captured image of a travel space being received;
acquiring identification information of the home appliance identified to be present based on travel map information including the identification information the home appliance present in the travel space and the first captured image if the home appliance is identified to be present in the first captured image;
acquiring information on function provided by the identified home appliance based on the acquired identification information;
identifying information corresponding to a user interface (UI) for providing a function of the identified home appliance together with the first captured image based on the acquired information on function; and
transmitting the identified information corresponding to the UI to a user terminal.

12. The method as claimed in claim 11, further comprising:
determining whether the home appliance is present within a threshold distance from a robot based on travel information received from the robot;
transmitting request information for obtaining a second captured image by using a camera included in the home appliance to the home appliance based on the home appliance being identified to be present within the threshold distance; and
receiving the second captured image acquired using the camera and transmit the received second captured image to the user terminal.

13. The method as claimed in claim 12, wherein the transmitting includes
storing the second captured image in the memory based on the second captured image being received, and
transmitting the stored second captured image to the user terminal based on the home appliance being identified to be present in the first captured image.

14. The method as claimed in claim 12, wherein the transmitting of the identified information corresponding to the UI to the user terminal includes
transmitting the information corresponding to the UI, in which the second captured image overlaps a location of the home appliance present in the first captured image, to the user terminal.

15. A non-transitory computer-readable recording medium storing computer instructions that cause an electronic apparatus to perform an operation if executed by a processor of the electronic apparatus, wherein the operation includes
determining whether a home appliance is present in a first captured image based on the first captured image of a travel space being received,
acquiring identification information of the home appliance identified to be present based on travel map information including the identification information of the home appliance present in the travel space and the first captured image if the home appliance is identified to be present in the first captured image,
acquiring information on function provided by the identified home appliance based on the acquired identification information,
identifying information corresponding to a user interface for providing a function of the identified home appliance together with the first captured image based on the acquired information on function, and
transmitting the identified information corresponding to the UI to a user terminal.

16. The non-transitory computer-readable recording medium as claimed in claim 15, wherein the operations further comprise:
determining whether the home appliance is present within a threshold distance from a robot based on travel information received from the robot;
transmitting request information for obtaining a second captured image by using a camera included in the home appliance within the threshold distance to the home appliance based on the home appliance being identified to be present within the threshold distance; and
receiving the second captured image acquired using the camera and transmit the received second captured image to the user terminal.

17. The non-transitory computer-readable recording medium as claimed in claim 16, wherein the transmitting includes:
storing the second captured image in the memory based on the second captured image being received, and
transmitting the stored second captured image to the user terminal based on the home appliance being identified to be present in the first captured image.

18. The non-transitory computer-readable recording medium as claimed in claim 16, wherein the transmitting of the identified information corresponding to the UI to the user terminal includes:
transmitting the information corresponding to the UI, in which the second captured image overlaps a location of the home appliance present in the first captured image, to the user terminal.

19. The non-transitory computer-readable recording medium as claimed in claim 15, wherein the operations further comprise:
receiving user movement information from the user terminal,
identifying whether a user movement magnitude is greater than or equal to a threshold value based on the received user movement information,
identifying control information for a robot to correspond to user movement based on identifying the user movement magnitude being greater than or equal to the threshold value, and
transmitting the identified control information to the robot.

20. The non-transitory computer-readable recording medium as claimed in claim 19, wherein the operations further comprise:
transmitting the second captured image corresponding to a first camera among a plurality of cameras included in the home appliance to the user terminal, and
transmitting the second captured image corresponding to a second camera to the user terminal based on receiving information on a selection of the second camera from the plurality of cameras from the user terminal.
